(19) United States
(12) Patent Application Publication
(10) Pub. No.: US 2010/0140887 A1
(43) Pub. Date: Jun. 10, 2010

(54) VEHICLE LOADABLE CART

(76) Inventors: Natan Yehiav, Matan (IL); Bosmat Libovsky, Matan (IL)

Correspondence Address: Pearl Cohen Zedek Latzer, LLP, 1500 Broadway, 12th Floor, New York, NY, 10036, US

(21) Appl. No.: 12/331,862

(22) Filed: Dec. 10, 2008

(51) Int. Cl. B62D 39/00

(52) U.S. Cl. 280/33.991

(57) ABSTRACT

A vehicle loadable cart for loading into a trunk of a vehicle, having a floor and a rear wall which is higher than the floor, is disclosed. The cart includes a chassis, a retractable main wheel assembly for supporting the chassis when transported over a ground surface, and at least one auxiliary wheel assembly with a deployment mechanism that is adapted to shift the auxiliary wheel assembly between a retracted state, in which the auxiliary wheel assembly is raised so as to allow the chassis to pass in a substantially horizontal position over the rear wall of the trunk, and a deployed state, in which said at least one auxiliary wheel assembly extends downward so as to support the chassis above the trunk floor at an elevation equal to or higher than the rear wall of the trunk, allowing wheeling the cart further into the trunk. When the cart is inside the trunk said at least one auxiliary wheel assembly may be retracted to lower the chassis onto the floor of the trunk.

### FIELD OF THE INVENTION

The present invention relates to carts. More particularly, the present invention relates to a vehicle loadable cart.

### BACKGROUND OF THE INVENTION

Carts are widely used in moving goods to and from automobiles and other vehicles. In general, a cart has a basket mounted on legs or a chassis provided with wheels or casters. Often, it is desirable to transport the cart together with its contents. The height of many carts, especially those carts intended for use by shoppers, is designed such that the cart may be comfortably filled, pushed, and emptied by a person of ordinary height. The desired height of the cart is generally achieved by making the legs of the cart sufficiently long so that the basket of the cart is at the desired height. Often, a cart whose height is convenient for shopping is too tall to fit as is into the cargo compartment of a typical passenger vehicle. For this reason, collapsible carts have been proposed.

For example, Duerr in EP1733947 and D'Angelo in US 2003/0197339 describe carts that are collapsible to a compact form for convenient stowing. However, the cart cannot be collapsed when filled, and must be emptied of its contents prior to being collapsed. Niehus in DE 20303702 describes a partially collapsible cart in which the basket may be lowered. No provision is made, however, for conveniently loading the partially collapsed cart into a vehicle.

Designs have been proposed for carts that may be loaded with their contents into vehicles. For example, Nugent in US 2008/0061531 describes a cart that can be pushed horizontally into a vehicle while simultaneously collapsing the legs of the cart. Miller in U.S. Pat. No. 6,575,491, Gines in U.S. Pat. No. 6,070,899, Navelier in FR 2850623, and Vasseur in FR 2775645 describe carts with wheels that extend forward near the bottom of the cart basket. The extended wheels are placed on the floor of the cargo area of the vehicle. The cart is then pushed forward horizontally into the vehicle while collapsing the legs of the cart. The wheels of the cart, or additional wheels provided on the legs, facilitate pushing the cart once the legs are partially or fully collapsed. These designs allow for convenient horizontal loading of the cart into a flat, open cargo compartment of a vehicle. Thus, convenient use of a cart with one of these designs is limited to vehicles that enable horizontal access to a flat cargo compartment, such as vans or station wagons. Such a cart cannot be conveniently loaded into the trunk of a sedan or other cargo compartment with a rear wall that blocks horizontal access to the compartment. In order to load the cart into a trunk, the cart would have to be lifted over the rear wall of the trunk.

Al-Toukhi in U.S. Pat. No. 6,045,150 describes a cart designed for stowing in the trunk of an automobile. In this design, a handle extends horizontally forward from the front legs of the cart. The front end of the cart is brought adjacent to the rear wall of the trunk of the automobile. The front legs of the cart are then folded up and back toward the bottom of the cart basket, such that the handle extends downward into the trunk. When the front legs are fully folded, the handle supports the front end of the basket. A pair of support legs that are attached perpendicularly to the front legs of the cart supports the rear end of the basket. The rear legs are folded up and over the rear end of the basket such that the ends of rear legs rest inside the basket. Therefore, a fully loaded cart must be at least partially emptied prior to loading into the trunk. No provision is made for supporting the front end of the basket during the process of folding the front legs of the cart. Also, the rear end of the basket must be lifted so that the supplemental support legs can clear the rear wall of the trunk. Therefore, a person who is not strong enough to lift the cart when it is loaded cannot place the loaded cart into the trunk while unassisted.

Therefore, there is a need for a cart that may be placed, while fully loaded, into the trunk of a vehicle by a single person, unassisted.

It is an object of the present invention to provide a cart that may be placed fully loaded by a single unassisted person into the trunk of a vehicle.

Other aims and advantages of the present invention will become apparent after reading the present invention and reviewing the accompanying drawings.

### SUMMARY OF THE INVENTION

There is thus provided, in accordance with some embodiments of the present invention, a vehicle loadable cart for loading into a trunk of a vehicle having a floor and a rear wall which is higher than the floor, the cart comprising:

a chassis;

a retractable main wheel assembly for supporting the chassis when transported over a ground surface;

at least one auxiliary wheel assembly with a deployment mechanism that is adapted to shift the auxiliary wheel assembly between a retracted state in which the auxiliary wheel assembly is raised so as to allow the chassis to pass in a substantially horizontal position over the rear wall of the trunk, and a deployed state in which said at least one auxiliary wheel assembly extends downward so as to support the chassis above the trunk floor at an elevation equal to or higher than the rear wall of the trunk, allowing wheeling the cart further into the trunk,

whereby when the cart is inside the trunk said at least one auxiliary wheel assembly may be retracted to lower the chassis onto the floor of the trunk.

Furthermore, in accordance with embodiments of the present invention, said at least one auxiliary wheel assembly comprises a front auxiliary wheel assembly for supporting a front portion of the chassis above the trunk floor.

Furthermore, in accordance with embodiments of the present invention, the retractable main wheel assembly and said at least one auxiliary wheel assembly cooperate.

Furthermore, in accordance with embodiments of the present invention, said at least one auxiliary wheel assembly comprises a front auxiliary wheel assembly and a rear auxiliary wheel assembly.

Furthermore, in accordance with embodiments of the present invention, the retractable main wheel assembly includes front legs and rear legs.

Furthermore, in accordance with embodiments of the present invention, the deployment mechanism is manually operable.

Furthermore, in accordance with embodiments of the present invention, the deployment mechanism is manually operable by a lever.

Furthermore, in accordance with embodiments of the present invention, the deployment mechanism includes a stored-energy element for assisting in the deployment of said at least one auxiliary wheel assembly.

Furthermore, in accordance with embodiments of the present invention, the stored-energy element comprises a spring.

Furthermore, in accordance with embodiments of the present invention, said at least one auxiliary wheel assembly is adjustable so as to adjust the elevation.

Furthermore, in accordance with embodiments of the present invention, the retractable main wheel assembly is adjustable so as to adjust the height of the chassis above the ground surface.

Furthermore, in accordance with embodiments of the present invention, the deployment mechanism is automatic.

Furthermore, in accordance with embodiments of the present invention, the deployment mechanism comprises a motor.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 schematically illustrates a vehicle loadable cart in accordance with some embodiments of the present invention.

FIG. 2A schematically illustrates deployment mechanism of a front auxiliary wheel assembly mechanism of the cart shown in FIG. 1.

FIG. 2B schematically illustrates a release mechanism for the deployment mechanism shown in FIG. 2A.

FIG. 2C schematically illustrates an unlocked state of the release mechanism shown in FIG. 2B.

FIG. 3 schematically illustrates a mechanism for retracting the auxiliary wheel assembly of the cart shown in FIG. 1.

FIG. 4A is a schematic side view of the cart shown in FIG. 1 when in position to be loaded into the trunk of a vehicle.

FIG. 4B schematically illustrates the cart shown in FIG. 4A with the front support legs deployed.

FIG. 4C schematically illustrates the cart shown in FIG. 4B in position to collapse the rear cart legs.

FIG. 4D schematically illustrates the cart shown in FIG. 4C with all support legs deployed.

FIG. 4E schematically illustrates the cart shown in FIG. 4D with support legs retracted.

FIG. 5 schematically illustrates a vehicle loadable cart with slanted front legs in accordance with some embodiments of the present invention.

FIG. 6A schematically illustrates a mechanism for deploying the front support legs of the cart shown in FIG. 5.

FIG. 6B schematically illustrates the mechanism of FIG. 6A with the front support legs deployed.

FIG. 7A schematically illustrates a mechanism for deploying the rear support legs of the cart shown in FIG. 5.

FIG. 7B schematically illustrates the mechanism of FIG. 7A with the rear support legs deployed.

FIG. 8A is a schematic side view of the cart shown in FIG. 5 when in position to be loaded into the trunk of a vehicle.

FIG. 8B schematically illustrates the cart shown in FIG. 8A with the front cart legs retracted.

FIG. 8C schematically illustrates the cart shown in FIG. 8B with the front support legs deployed.

FIG. 8D schematically illustrates the cart shown in FIG. 8C in position to retract the rear cart legs.

FIG. 8E schematically illustrates the cart shown in FIG. 8D with the rear main wheel assembly retracted.

FIG. 8F schematically illustrates the cart shown in FIG. 8E with all support legs deployed.

FIG. 8G schematically illustrates the cart shown in FIG. 8F entirely within the trunk of a vehicle.

FIG. 8H schematically illustrates the cart shown in FIG. 8G with support legs retracted.

FIG. 9 schematically illustrates a vehicle loadable cart with slanted front legs and separate handles for deploying support legs, in accordance with some embodiments of the present invention.

FIG. 10A is a schematic side view of the cart shown in FIG. 9 when in position to be loaded into the trunk of a vehicle.

FIG. 10B schematically illustrates the cart shown in FIG. 10A with front support legs deployed.

FIG. 10C schematically illustrates the cart shown in FIG. 10B with front legs retracted.

FIG. 10D schematically illustrates the cart shown in FIG. 10C with horizontally folded retracted front legs.

FIG. 10E schematically illustrates deploying the rear support legs of the cart shown in FIG. 8D.

FIG. 10F schematically illustrates the cart shown in FIG. 10E with all support legs deployed.

FIG. 10G schematically illustrates the cart shown in FIG. 10F with rear legs retracted.

FIG. 10H schematically illustrates the cart shown in FIG. 10G with horizontally folded retracted rear legs.

FIG. 10I schematically illustrates retracting the support legs of the cart shown in FIG. 10H.

FIG. 10J schematically illustrates the cart shown in FIG. 10I with support legs retracted.

### DETAILED DESCRIPTION OF EMBODIMENTS

A vehicle loadable cart in accordance with embodiments of the present invention is designed to be placed into the trunk of a vehicle while fully loaded or empty. The cart includes a chassis that typically includes a main wheel assembly on which the chassis is wheeled across a supporting ground. A receptacle into which objects may be placed, such as a basket, may be mounted on the chassis. Alternatively, the chassis may support a reusable flexible bag or a rigid case. The bag may be constructed of heavy cloth, plastic, or any other durable, flexible, and washable material. The bag may be closable by means of a zipper, or other appropriate closing mechanism.

The main wheel assembly may include a pair of front cart legs and a pair of rear cart legs The bottom ends of the legs are provided with wheels or casters. A push handle is provided at a convenient height so as to enable a person of ordinary height to comfortably push the cart. The legs are sufficiently long so as to enable a person of ordinary height to comfortably place objects into the receptacle, or to remove objects from the receptacle, while standing adjacent to the cart. Thus, a person may comfortably fill the receptacle and bring the loaded cart to the trunk of a vehicle. The main wheel assembly is retractable. When the main wheel assembly is retracted, the chassis may be supported by one or more auxiliary wheel assemblies as described below. When the auxiliary wheel assemblies are also retracted, the chassis rests on the surface on which it is placed. In the context of this description, “retractable” and “retracting” refer to any manner of folding, collapsing, withdrawing, hiding away, or any other method of causing an assembly to no longer be deployed. The height of the main wheel assembly may be adjustable so as to adjust the height of the chassis. The height may be adjusted, for example, for the convenience of a person using the cart, or to pass horizontally over the wall of the trunk.

The design of the cart enables a single unassisted person to place the loaded cart into the trunk of a vehicle. This is accomplished by providing the cart with one or more deployable auxiliary wheel assemblies to support the chassis above the floor of the trunk. In some embodiments of the present invention, one auxiliary wheel assembly may be provided to support one part (typically the front portion) of the chassis. Alternatively, two auxiliary wheel assemblies may be provided, one designed to support the front portion of the cart, and the other to support the rear portion of the cart. An auxiliary wheel assembly includes one or more (typically two) short deployable support legs that are deployed from the front or rear of the cart chassis. The front of the loaded cart is brought up to the opening of the trunk, near the rear wall of the trunk. The front deployable support legs, which may initially be in a retracted state beneath the cart, are then deployed, extending from the front of the cart to the floor of the trunk. The deployed front support legs hold the front end of the chassis above the rear wall of the trunk. In embodiments of the present invention, the length of the front and rear support legs may be adjustable so as to adapt the auxiliary wheel assemblies, and specifically the support legs to the trunk of a specific vehicle. The support legs are provided with casters in order to enable the support legs to roll on the floor of the trunk. The front support legs support the front end of the chassis as part or all of the main wheel assemblies are folded to a stowed state. For example, the front legs of the cart may be collapsed, folded, or retracted. Depending on the embodiment of the present invention, the front support legs are deployed prior to or concurrently with retraction of the front cart legs. In some embodiments of the present invention, folding the front cart legs, or applying a force to fold the front cart legs, causes the front support legs to deploy concurrently with the folding of the front cart legs. Alternatively, the front support legs are deployed by means of a separate mechanism. The front support legs may be extended by a spring loaded mechanism, or other similar mechanism with a stored energy element. In some embodiments of the present invention, the front end of the chassis may rest on the rear wall of the trunk during retraction of the front cart legs until the front support legs are fully deployed. The height of each support leg plus the height of the floor of the trunk is designed to be approximately equal to the height of each rear leg, or designed to be adjustable to facilitate that relation. Thus, when the chassis is being supported by the front support legs and the rear cart legs of the main wheel assembly, and when the surface on which the cart and the vehicle are standing is substantially level, the chassis is held substantially level. Collapsing the front legs enables the chassis to be pushed horizontally forward, further into the trunk.

When the chassis has been pushed sufficiently into the trunk, the pair of rear support legs may be deployed so as to extend from the rear of the chassis to the floor of the trunk. The rear support legs support the rear end of the chassis while the rear legs of the main wheel assembly of the cart are being collapsed, folded, or retracted. Depending on the embodiment of the present invention, the rear support legs are deployed before or concurrently with retraction of the rear legs of the main wheel assembly. In some embodiments of the present invention, the rear portion of the chassis may rest on the rear wall of the trunk during retraction of the rear cart legs until the rear support legs are fully deployed. In some embodiments of the present invention, the legs of the main wheel assembly cooperate with the support legs of the auxiliary wheel assemblies. With cooperating wheel assemblies, operating the main wheel assembly (f example, retracting or folding the main wheel assembly or part thereon) causes deployment or retraction of an auxiliary wheel assembly. For example, folding the rear cart legs, or applying a force to fold the rear cart legs, causes the rear support legs to deploy automatically. Alternatively, the rear support legs are deployed manually by means of a separate mechanism, such as a lever or handle. The rear support legs may be deployed by means of a spring loaded mechanism or other stored energy element. The remainder of the chassis may then be pushed horizontally into the trunk. When the chassis is fully within the trunk of the vehicle, both pairs of support legs may be retracted. Retracting the support legs causes the chassis to be lowered to the floor of the trunk. Lowering the chassis to the floor of the trunk may be necessary in order to allow the cover of the trunk to close. In addition, resting the bottom of the chassis on the floor of the trunk, rather than on the support legs and casters, increases the stability of the chassis and immobilizes it. This may prevent the chassis from sliding or tipping over when the vehicle is in motion.

In order to remove the cart from the trunk of the vehicle, the procedure is reversed: The front and rear support legs are extended. In embodiments of the present invention, a spring loaded or other stored energy element mechanism may be provided to assist in extending the support legs when the cart legs are collapsed. With a spring loaded mechanism, a person operates a release mechanism to enable the spring loaded mechanism to assist in extending the support legs. The spring loaded mechanism (or other powered mechanism that includes an energy stored element, such as, for example, pneumatic mechanism, hydraulic mechanism) minimizes the effort that must be expended by a person in order to extend the support legs when the cart legs are collapsed. The person then begins to pull the chassis horizontally toward the rear of the trunk. When the rear end of the chassis extends over the rear trunk wall out of the trunk, the user lowers and deploys the rear cart legs. In some embodiments of the present invention, deploying the rear cart legs causes the rear support legs to retract. In other embodiments of the present invention, the rear support legs are retracted by means of a separate mechanism after the rear cart legs have been deployed. In some embodiments of the present invention, the rear end of the chassis rests on the rear trunk wall until the rear cart legs are fully deployed. Retracting the rear support legs enables the rear end of the cart to be pulled horizontally further out of the trunk, supported by the rear cart legs and the front support legs. As the front of the chassis is removed from the trunk, the front cart legs are deployed. In some embodiments of the present invention, deploying the front cart legs causes the front support legs to retract. In other embodiments of the present invention, the front support legs are retracted by means of a separate mechanism after the front cart legs have been deployed. In some embodiments of the present invention, the rear end of the chassis rests on the rear trunk wall until the rear cart legs are fully deployed. Deploying the front cart legs and retracting the front support legs enables the cart to be pulled completely out of the trunk, and away from the vehicle. A locking mechanism may be provided to lock the front and rear cart legs in the deployed position, preventing accidental collapse of the cart legs.

During placement of the cart into a trunk and removal of the cart from the trunk, it is desired that a person not be required to lift or support the chassis at any time. Thus, embodiments of the present invention enable an unassisted user who is not capable of lifting or supporting the cart with its contents to load, or unload, the cart with its contents into the trunk of a vehicle.

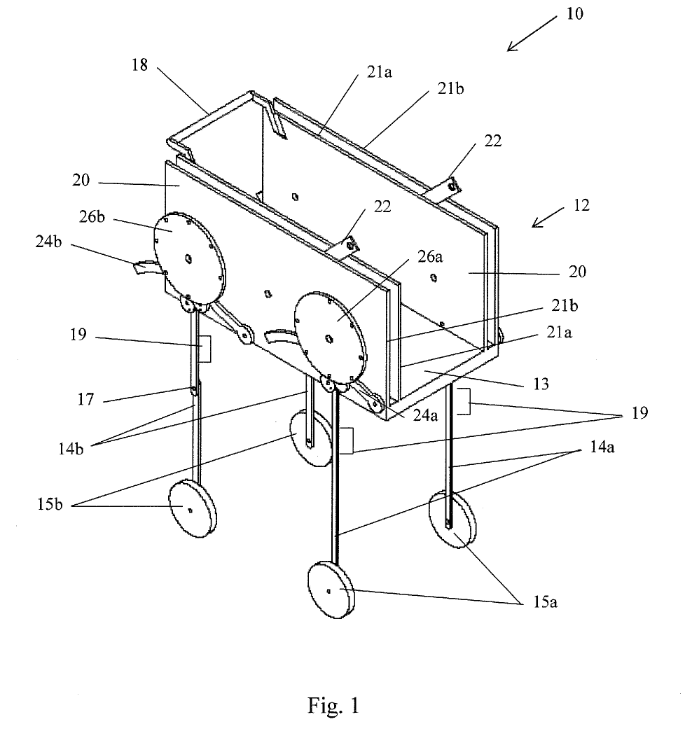

FIG. 1 schematically illustrates a vehicle loadable cart in accordance with some embodiments of the present invention. Chassis 12 of cart 10 rests on front cart legs 14a and rear cart legs 14b. In general, the construction of cart 10 may be symmetrical from right to left. The bottom ends of front cart legs 14a are provided with front wheels 15a, and rear cart legs 14b are provided with rear wheels 15b. Push handle 18 is attached to chassis 12, and enables a user to cause cart 10 to roll on wheels 15a and 15b. Chassis 12 includes chassis bottom 13 and side walls 20. Each of side walls 20 is double. Each side wall 20 includes an inner wall panel 21a and an outer wall panel 21b. Various components of a leg deploying and collapsing mechanism, for example handles 22, may be mounted in the space between inner wall panel 21a and outer wall panel 2 1b, so as to hide it away and restrict accessing it.

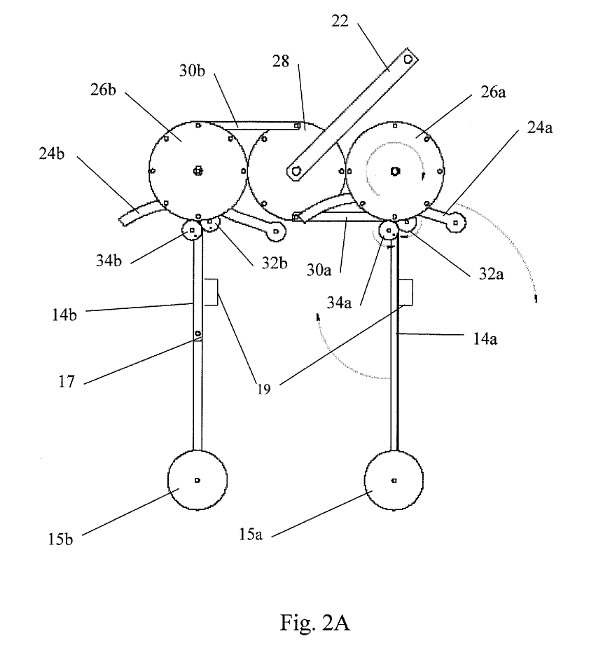

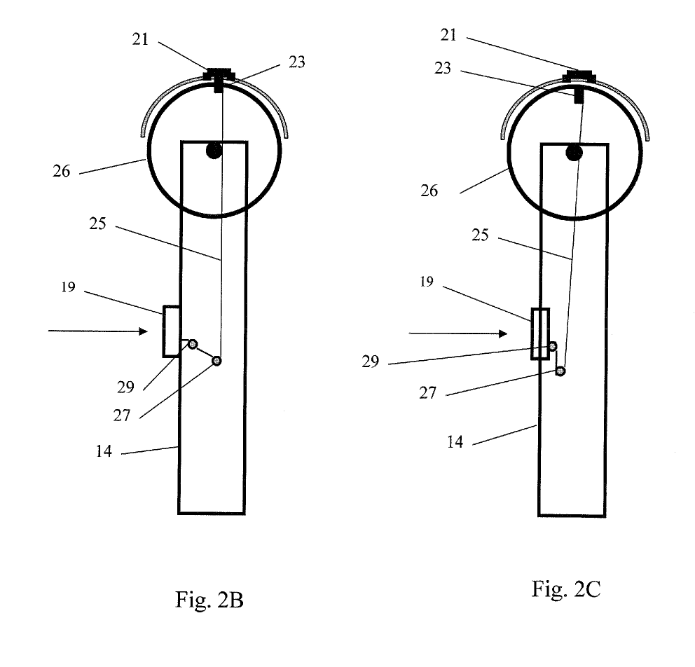

During the course of loading cart 10 into the trunk of a vehicle, front support legs 24a and rear support legs 24b are deployed. FIG. 2A schematically illustrates a deployment mechanism of a front auxiliary wheel assembly mechanism of the cart shown in FIG. 1. Folding front cart legs 14a operates the mechanism for deploying front support legs 24a. Folding front cart leg 14a upward and rearward (toward the rear of the cart) turns gear wheel 26a. Rotation of gear wheel 26a causes rotation of gear 34a, in turn causing rotation of gear 32a. Rotation of gear 32a causes support leg 24a to extend frontward (toward the front of the cart) and downward. Folding rear cart leg 14b causes similar rotation of gear wheel 26b, gear 34b, and gear 32b, similarly extending rear support leg 24b frontward and downward. Right and left front cart legs 14a may be connected to one another by means of one or more horizontal or diagonal bars. In addition, or alternatively, gear 34a or gear 32a on one side of the cart may be connected by means of an axle to a symmetrically placed gear on the opposite side of the cart. Such a connection may enable concurrent and even deployment of front support legs 24a on both the right and left sides of the cart.

In some embodiments of the present invention, contact of a cart leg (front or rear) with the rear bumper of a vehicle triggers a pressure sensitive release mechanism mounted on one or both of a pair of cart legs. The release mechanism enables that leg to fold and the associated support legs of the auxiliary wheel assembly to deploy. FIG. 2B schematically illustrates a release mechanism for the deployment mechanism shown in FIG. 2A. Ordinarily, when cart leg 14 is extended, bolt 23 extends into recess 21, preventing rotation of gear wheel 26 and folding of cart leg 14. Thus, the cart leg is locked in an extended state. An optional user-operated locking mechanism (not shown) may prevent accidental removal of bolt 23 from recess 21 by accidental triggering of the release mechanism. The user-operated locking mechanism may be located on the handle of the cart, or any other location convenient for a user. When cart leg 14 is brought into contact with the rear bumper of a vehicle, trigger 19 is pressed. Pressing trigger 19 causes, for example, by means of a rack and pinion mechanism 29, joint 27 to rotate downward. Downward rotation of joint 27 pulls shaft 25 and bolt 23 downward. Pulling bolt 23 downward removes bolt 23 from recess 21, unlocking gear wheel 26. FIG. 2C schematically illustrates an unlocked state of the release mechanism shown in FIG. 2B. When in the unlocked state, further pressing on the cart legs may cause the cart legs to fold upward, extending the associated support legs of the auxiliary wheel assembly. Alternatively, the leg locking and release mechanism may employ another mechanism to enable locking and folding of the cart legs, including a spring-loaded, cable, latch, or other mechanical mechanism, or an electromagnetic, pneumatic, hydraulic, or any other suitable mechanism known in the art for locking and releasing the cart legs. The release mechanism may be triggered by a signal generated by a mechanical, electromagnetic, acoustic, optical, or other sensor that detects the proximity of the cart to the trunk of a vehicle.

Alternatively to the mechanism shown in FIG. 2A for extending the support legs of the auxiliary wheel assembly, a spring-loaded, pneumatic, electromagnetic, electromechanical, motorized, or other automatically operable deployment mechanism may extend the support legs frontward and downward. The deployment of the automatic deployment mechanism may be triggered by a manual mechanism such as a handle or lever or by folding the cart legs. Alternatively, the deployment of the automatic deployment mechanism may be triggered by an automatic mechanism such as the cart leg release mechanism, by a signal generated by a proximity sensor, or other suitable triggering mechanism known in the art. When the spring loaded deployment mechanism has caused the support legs to extend sufficiently (e.g. can support the cart chassis above the wall of a trunk), a latch, ratchet, or other locking mechanism may lock the support legs in their extended, deployed position. With such an automatic deployment mechanism, front support legs 24a may be deployed so as to support the front end of the chassis prior to the folding of front cart legs 14a. A similar automatic deployment mechanism may deploy rear support legs 24b prior to the folding of rear cart legs 14b.

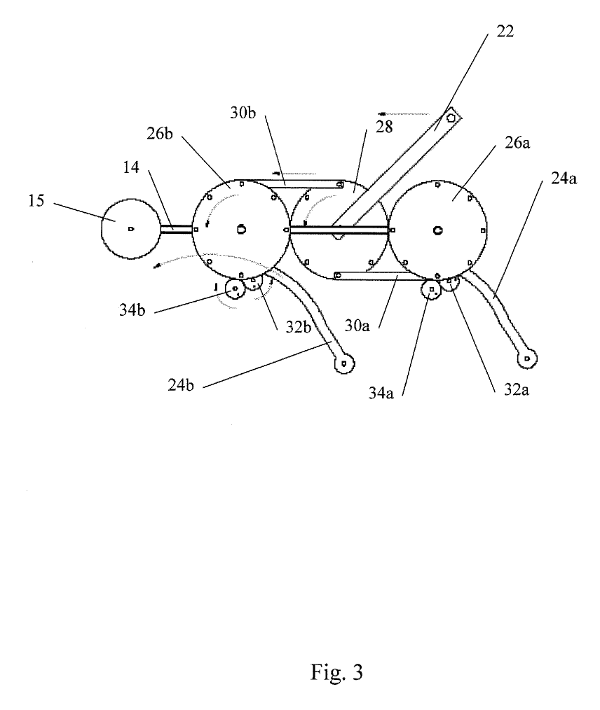

Once the cart is loaded into the trunk of a vehicle, the support legs are retracted so that the bottom of the chassis rests on the floor of the trunk. FIG. 3 schematically illustrates a mechanism for retracting the support legs of the cart shown in FIG. 1. The cart legs, such as front cart leg 14a, are in their folded positions. In order to retract support legs 24a and 24b, handle 22 is rotated toward the rear of the cart. Rotating handle 22 toward the rear turns wheel 28. Wheel 28 is located between inner wall panel 21a and outer wall panel 21b. Rotation of wheel 28 moves rod 30b to the rear and rod 30a to the front. Rearward motion of rod 30b rotates gear wheel 26b, causing rotation of gear 34b, which in turn causes rotation of gear 32b. Rotation of gear 32b causes rear support leg 24b to retract upward and rearward. Similarly, the frontward motion of rod 30a causes rotation of gear wheel 26a, gear 34a, and gear 32a, and retraction of front support leg 24a.

In some embodiments of the present invention, retracting support legs 24a and 24b loads one or more spring-loaded or other stored energy mechanisms (not shown). At a later time, when a release mechanism is triggered, the loaded spring mechanisms may extend and deploy the support legs. Alternatively, the spring mechanism may be replaced by a hydraulic, compressed gas, or any other stored energy element mechanism capable of applying a restoration force to extend the support legs.

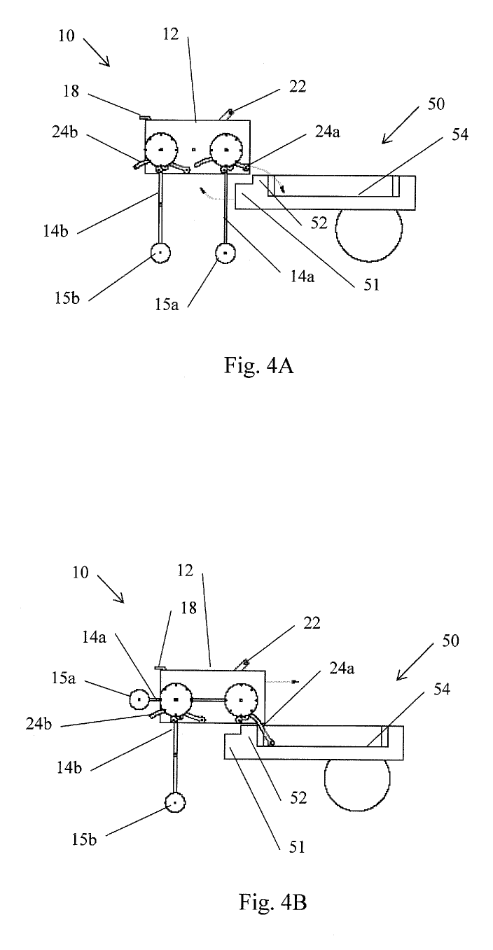

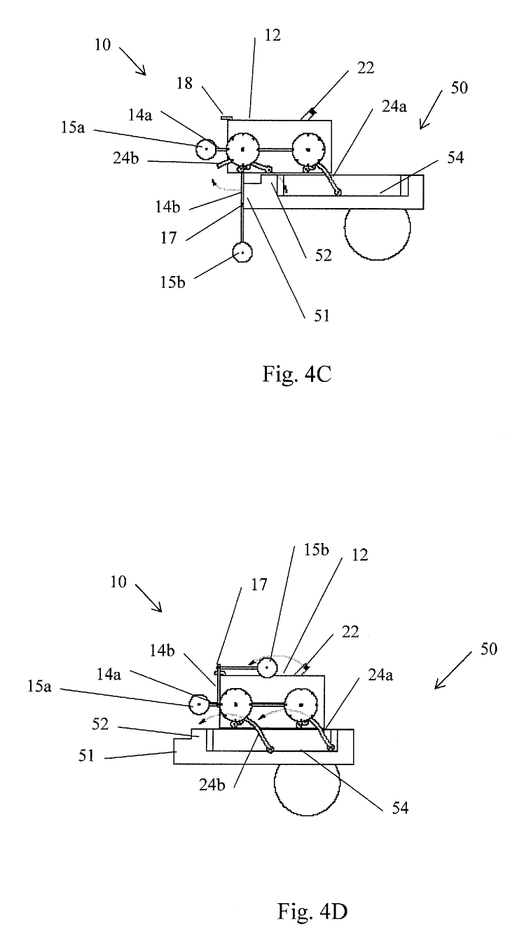

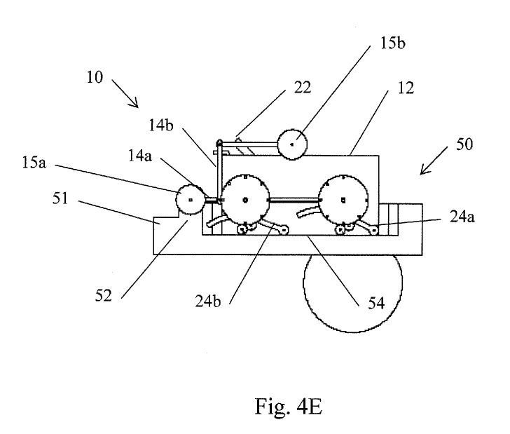

Mechanisms for deploying and retracting the support legs enable an unassisted user to place a loaded cart into the trunk of a vehicle. A procedure for placing cart 10 into the trunk of a vehicle is illustrated in FIG. 4A-FIG. 4E. FIG. 4A is a schematic side view of the cart shown in FIG. 1 when in position to be loaded into the trunk of a vehicle. The front end of cart 10 is brought up to rear trunk wall 52 of trunk 50 of a vehicle. As cart 10 is pushed forward toward trunk 50, front cart legs 14a are folded rearward and upward. Folding front cart legs 14a rearward and upward deploys front support legs 24a by means of the mechanism illustrated in FIG. 2A. In some embodiments of the present invention, a person folds front cart legs 14a manually. Alternatively, contact between front cart legs 14a and rear bumper 51 of the vehicle causes (for example, by means of the mechanism shown in FIG. 2A) front support legs 24a to deploy, and front cart legs 14a to fold rearward and upward. Front support legs 24a extend forward and downward until front support legs 24a extend over rear trunk wall 52 to trunk floor 54. In some embodiments of the present invention, an automatic mechanism automatically deploys front support legs 24a. In such a case, the bottom ends of front support legs 24a, when first deployed, may be suspended a short distance, for example, one centimeter or less, above trunk floor 54. Folding front cart legs 14a then lowers the front end of chassis 12 through the short distance.

FIG. 4B schematically illustrates the cart shown in FIG. 4A with the front support legs deployed. The front end of chassis 12 is supported by front support legs 24a, while the rear end of chassis 12 is supported by rear cart legs 14b. Cart 10 may now be pushed horizontally forward into trunk 50. FIG. 4C schematically illustrates the cart shown in FIG. 4B in position to collapse the rear cart legs. Rear cart legs 14b now abut rear bumper 51. Rear cart legs 14b are folded rearward and upward. Rear cart legs 14b are bent at joint 17, enabling the lower part of rear cart legs 14b and rear wheels 15b to fold over the top of chassis 12. Folding rear cart legs 14b rearward and upward deploys rear support legs 24b. Rear support legs 24b extend forward and downward over rear trunk wall 52 to trunk floor 54. In some embodiments of the present invention, a spring-loaded, or other automatic, mechanism deploys rear support legs 24b. In such a case, the bottom ends of rear support legs 24b, when first deployed, may be suspended a short distance, for example, one centimeter or less, above trunk floor 54. Folding rear cart legs 14b then lowers the rear end of chassis 12 through the short distance.

FIG. 4D schematically illustrates the cart shown in FIG. 4C with all support legs deployed. Rear legs 14b are folded over the rear end and top of chassis 12. As shown in FIG. 4D, chassis 12 has been pushed entirely into trunk 50. The user now rotates handle 22 toward the rear of the cart. Rotating handle 22 toward the rear causes front support legs 24a and rear support legs 24b to retract by means of the mechanism illustrated in FIG. 3. FIG. 4E schematically illustrates the cart shown in FIG. 4D with support legs retracted. Chassis 12 is now resting stably on trunk floor 54. The cover of trunk 50 may now be closed.

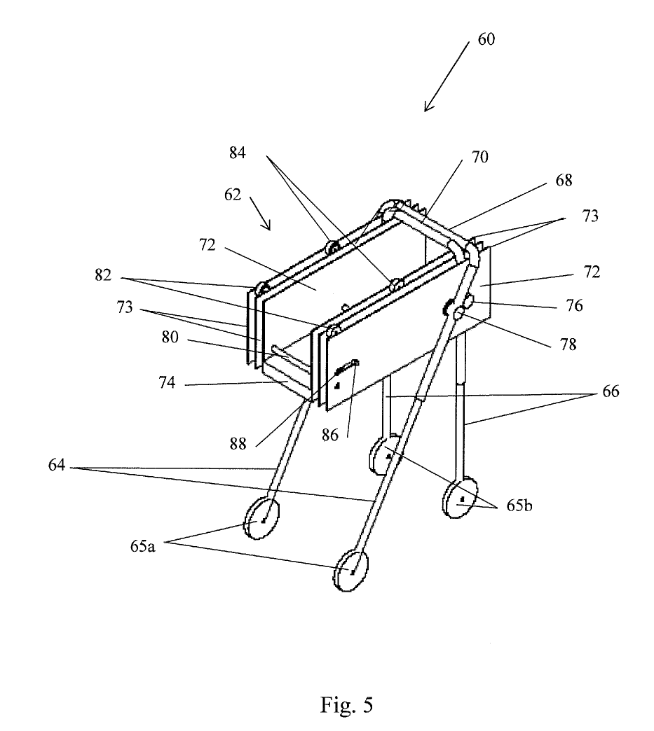

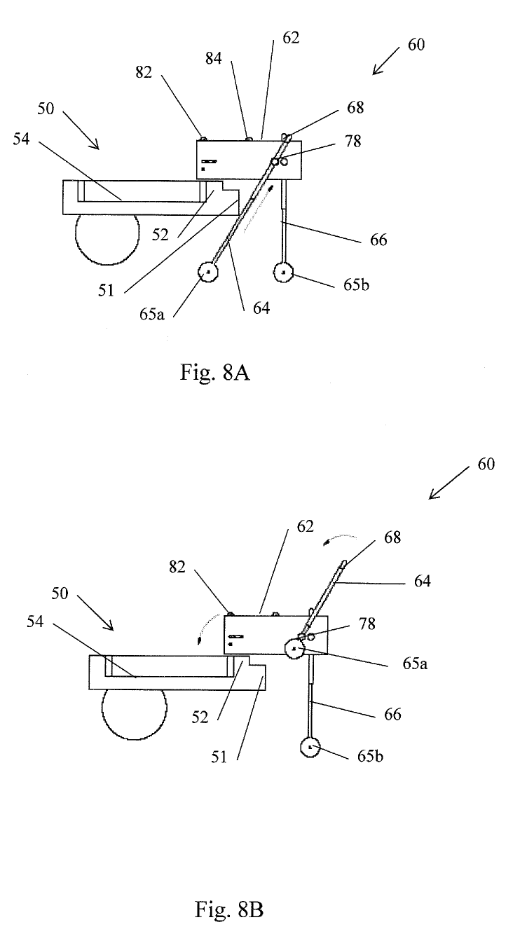

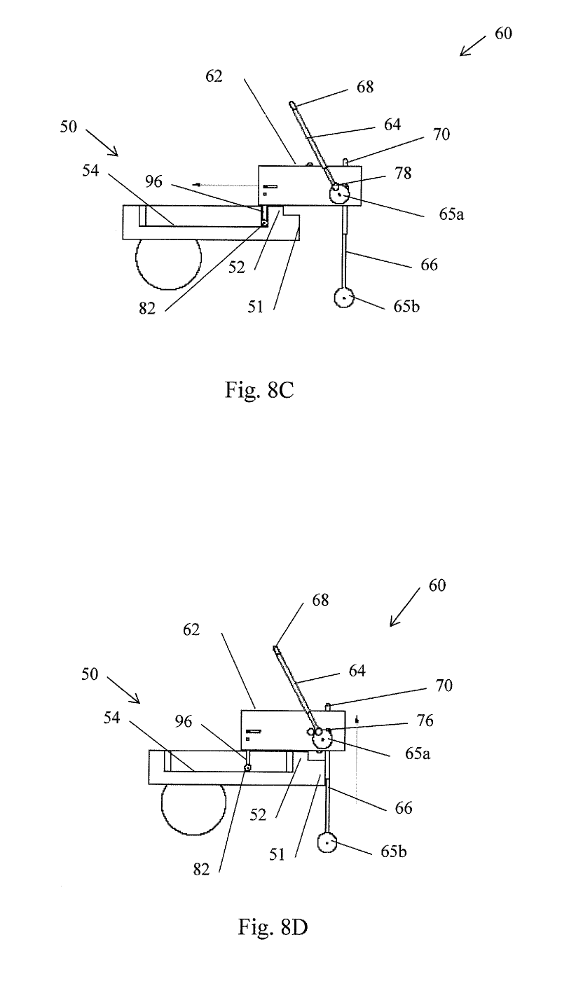

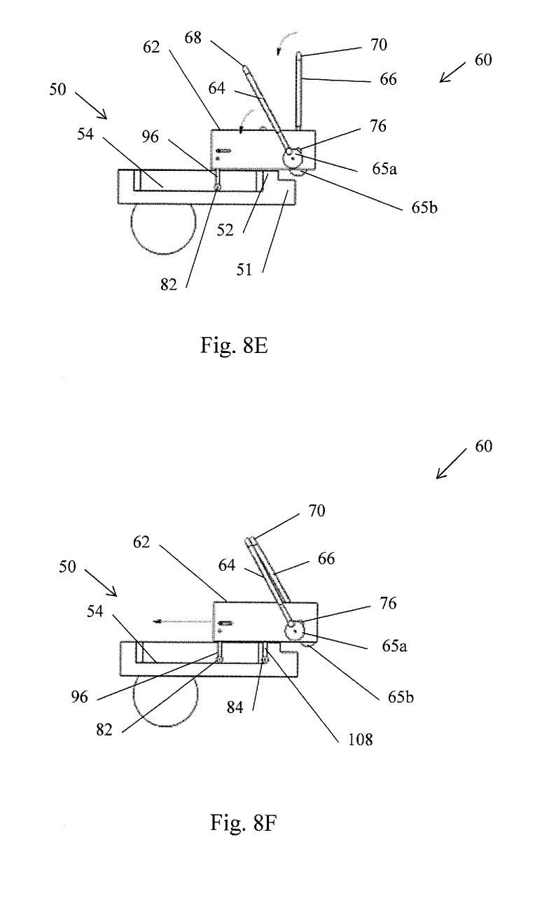

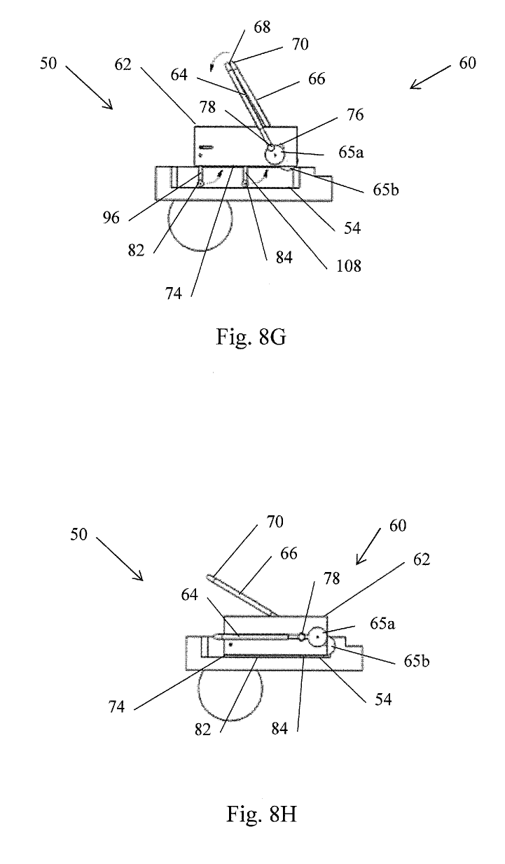

In other embodiments of the present invention, the front cart legs are slanted so as to enable the cart chassis to extend partially into the trunk prior to deploying the front support legs. In this manner, deployed cart legs may extend vertically downward from the bottom of the cart chassis. FIG. 5 schematically illustrates a vehicle loadable cart with slanted front legs in accordance with some embodiments of the present invention. Chassis 62 of cart 60 rests on front cart legs 64 and rear cart legs 66. The bottom ends of front cart legs 64 are provided with front wheels 65a, and rear cart legs 66 are provided with rear wheels 65b. Handle 68 is connected to front cart legs 64, and handle 70 is connected to rear cart legs 66. Chassis 62 includes chassis bottom 74 and side walls 72. Front cart legs 64 are slanted so as to extend downward and forward from axis 78, located near the rear of cart 60. The slant of front cart legs 64 may enable the rear bumper of a vehicle to fit within the space between front cart legs 64 and chassis bottom 74. This enables the front end of chassis 62 to extend over the top of the rear wall of the trunk of a vehicle (as shown in FIG. 8A). Each of side walls 72 consists of three parallel wall panels 73. Various components of leg deploying and collapsing mechanisms may be located in the spaces between wall panels 73.

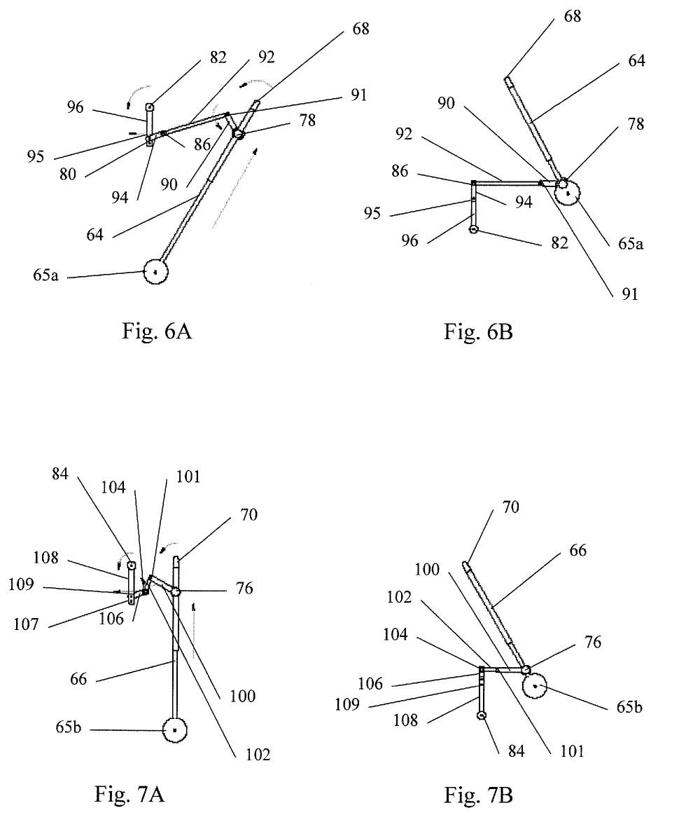

During the course of loading cart 60 into the trunk of a vehicle, front support legs and rear support legs of an auxiliary wheel assembly are deployed. FIG. 6A schematically illustrates a mechanism for deploying the front support legs of the cart shown in FIG. 5. As shown in FIG. 6A, front cart leg 64 is extended and front support leg 96 is folded upward. In order to retract front cart leg 64, handle 68 is pulled diagonally upward and rearward, pulling front cart legs 64 in the same direction until front wheels 65a meet axis 78. At this point, front cart legs 64 may be shortened by means of a telescoping mechanism. Shortened front cart legs 64 now extend diagonally upward and rearward of axis 78. Handle 68 and front cart legs 64 are now rotated frontward about axis 78, turning axis 78. Rotation of axis 78 swings arm 90 about axis 78. The motion of arm 90 pushes on arm 92. Arm 90 is connected to arm 92 by means of one-way joint 91. One-way joint 91 is capable of bending in one direction only. Motion of the distal end of arm 92 is constrained by confinement of pin 86 to slot 88 (shown in FIG. 5). Therefore, pin 86 slides to the left, and applies a torque to front support leg 96 through arm 94. Arm 94 is connected to front support leg 96 by means of one-way joint 95. One-way joint 95 is capable of bending in one direction only. The applied torque causes front support leg 96 to rotate about axis 80. The rotation of front support leg 96 continues until front support leg 96 and arm 94 are locked by one-way joint 95 in a linearly aligned position extending vertically downward from pin 86. At this point, arms 90 and 92 are locked by one-way joint 91 in a linearly aligned position extending horizontally. Front caster 65a extends downward, and front support leg 96 is deployed. FIG. 6B schematically illustrates the mechanism of FIG. 6A with the front support legs deployed. Further counterclockwise rotation of front cart leg 64 causes the locked pair of arm 94 and front support leg 96 to rotate. The rotation retracts front support leg 96 and front caster 65a into the bottom of a space between wall panels of a side wall of the cart.

FIG. 7A schematically illustrates a mechanism for deploying the rear support legs of the cart shown in FIG. 5. As shown in FIG. 7A, rear cart legs 66 are deployed and rear support legs 108 are folded. In order to retract rear cart legs 66, handle 70 is pulled vertically upward, pulling rear cart legs 66 upward until rear wheels 65b meet axis 76. At this point, rear cart legs 66 may be shortened by means of a telescoping mechanism. Alternatively, each of rear cart legs 66 may include joint (not shown) near the middle of its length. Rear cart legs 66 may then be shortened by being folded at the joint. Shortened rear cart legs 66 now extend vertically upward from axis 76. Handle 70 and rear cart legs 66 are now rotated frontward about axis 76, turning axis 76. Rotation of axis 76 swings arm 100 about axis 76. The motion of arm 100 pushes on arm 102. Arm 100 is connected to arm 102 by means of one-way joint 101. One-way joint 101 is capable of bending in one direction only. Motion of the distal end of arm 102 is constrained by confinement of a pin (not shown) on joint 104 at the distal end of arm 102 to a slot (not shown). Therefore, joint 104 slides to the left, and applies a torque to rear support leg 108 through arm 106. Arm 106 is connected to front support leg 108 by means of one-way joint 109. One-way joint 109 is capable of bending in one direction only. The applied torque causes rear support leg 108 to rotate about axis 107. The rotation of rear support leg 108 continues until rear support leg 108 and arm 106 are locked by one-way joint 109 in a linearly aligned position extending vertically downward from joint 104. Arms 100 and 102 are locked by one-way joint 101 in a linearly aligned position extending horizontally. Rear caster 65b extends downward and rear support leg 108 is deployed. FIG. 7B schematically illustrates the mechanism of FIG. 7A with the rear support legs deployed. Further rotation of rear cart leg 66 causes the locked pair of arm 106 and rear support leg 108 to rotate further. The further rotation retracts rear support leg 108 and rear caster 65b into the bottom of a space between wall panels of a side wall of the cart.

Mechanisms for deploying and retracting the support legs of an auxiliary wheel assembly enable an unassisted user to place a loaded cart into the trunk of a vehicle. A procedure for placing cart 60 into the trunk of a vehicle is illustrated in FIG. 8A-FIG. 8H. FIG. 8A is a schematic side view of the cart shown in FIG. 5 when in position to be loaded into the trunk of a vehicle. The front end of cart 60 is brought up to above rear trunk wall 52 of trunk 50 of a vehicle (only the trunk is shown in this figure). The front end of chassis 62 extends over rear trunk wall 52, and front cart legs 64 abut rear bumper 51. Handle 68 is lifted diagonally upward and toward the rear of cart 60. Lifting handle 68 retracts front cart legs 64 to above axis 78. FIG. 8B schematically illustrates the cart shown in FIG. 8A with the front cart legs retracted. The front end of chassis 62 is supported by rear trunk wall 52. Handle 68 and retracted front cart legs 64 are rotated about axis 78 toward the front of the cart. Rotating handle 68 causes the front support legs to deploy by rotating downward around the front of chassis 62, by means of the mechanism illustrated in FIG. 6. Handle 68 is rotated until the front support legs extend downward from the front of chassis 62. A stop or click mechanism may be provided in order to prevent unintentional rotation of handle 68 beyond the point that the support legs extend downward. FIG. 8C schematically illustrates the cart shown in FIG. 8B with the front support legs deployed. Front support legs 96 extend downward from chassis 62. Front casters 82 are resting on trunk floor 54. Chassis 62 is now supported by front support legs 96 and rear cart legs 66. Chassis may be pushed forward on front casters 82 and rear wheels 65b, further into trunk 50.

FIG. 8D schematically illustrates the cart shown in FIG. 8C in position to retract the rear cart legs. Rear cart legs 66 abut rear bumper 51. Handle 70 is lifted vertically upward, retracting rear cart legs 66 to above axis 76. FIG. 8E schematically illustrates the cart shown in FIG. 8D with the rear cart legs retracted. The rear end of chassis 62 is supported by rear trunk wall 52. Handle 70 and retracted rear cart legs 66 are rotated toward the front of chassis 62 about axis 76. Rotating handle 70 causes the rear support legs to rotate forward and downward within spaces between wall panels of the side walls of chassis 62, by means of the mechanism illustrated in FIG. 7. Handle 70 is rotated until the rear support legs extend downward from the rear of chassis 62. A stop or click mechanism may be provided in order to prevent unintentional rotation of handle 70 beyond the point that the support legs extend downward.

FIG. 8F schematically illustrates the cart shown in FIG. 8E with all support legs deployed. Chassis 62 is supported by front support legs 96 and rear support legs 108. Chassis 62 may now be pushed forward into trunk 50 on front casters 82 and rear casters 84 until chassis 62 is entirely inside trunk 50. FIG. 8G schematically illustrates the cart shown in FIG. 8F entirely within the trunk of a vehicle. In order to improve the stability of chassis 62 when the vehicle is in motion, the support legs are retracted. In order to retract front support legs 96 and rear support legs 108, handles 68 and 70 are further rotated toward the front end of chassis 62. Further rotating handles 68 and 70 toward the front end of chassis 62, causes front support legs 96 and rear support legs 108 to rotate upward and toward the rear of chassis 62 (counterclockwise in FIG. 8G). As front support legs 96 and rear support legs 108 rotate upward and rearward, chassis 62 descends. Chassis 62 descends until front support legs 96 and rear support legs 108 rotate into spaces between wall panels of the side walls of chassis 62. FIG. 8H schematically illustrates the cart shown in FIG. 4G with support legs retracted. At this point, chassis bottom 74 of chassis 62 is resting stably on trunk floor 54. The cover (not shown) of trunk 50 may now be closed.

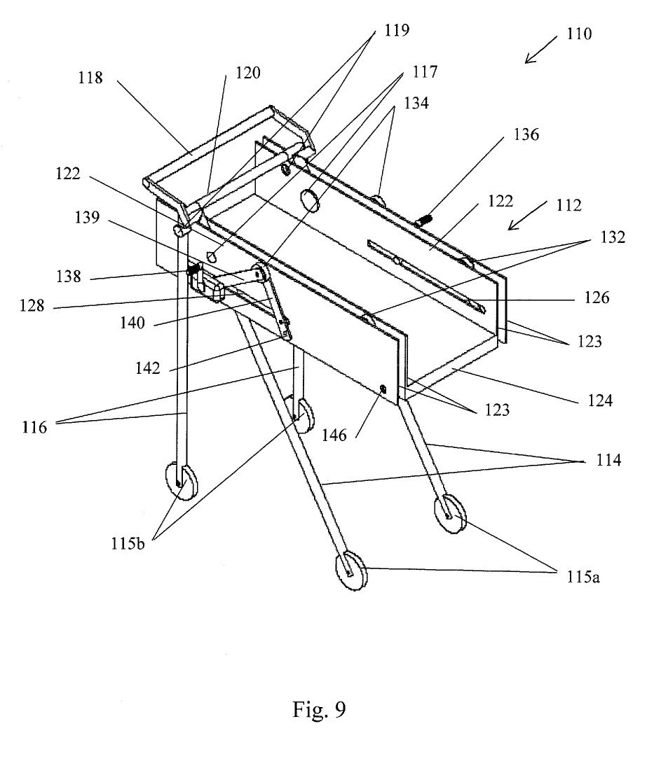

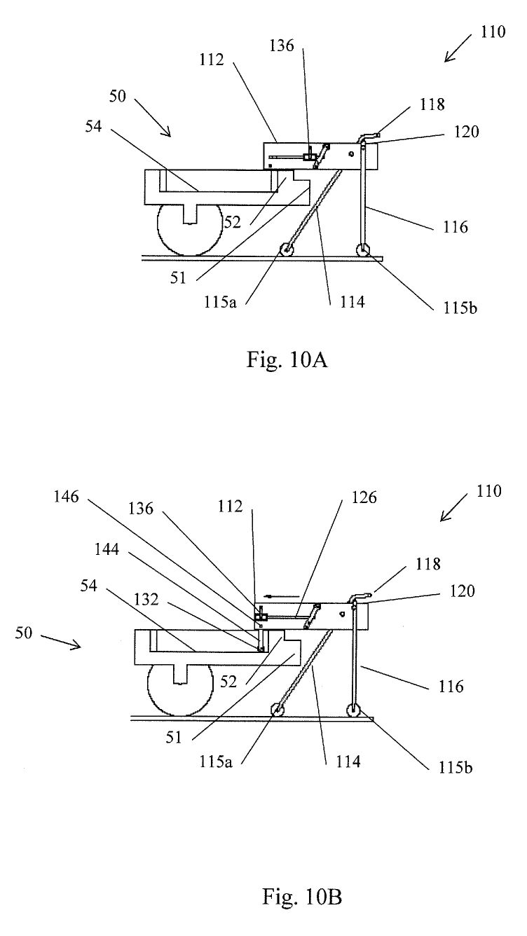

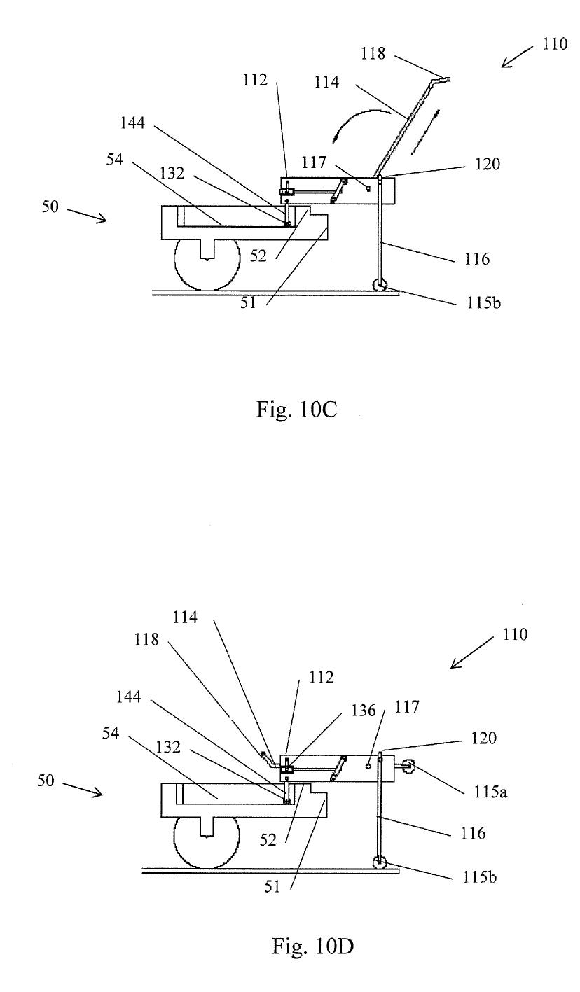

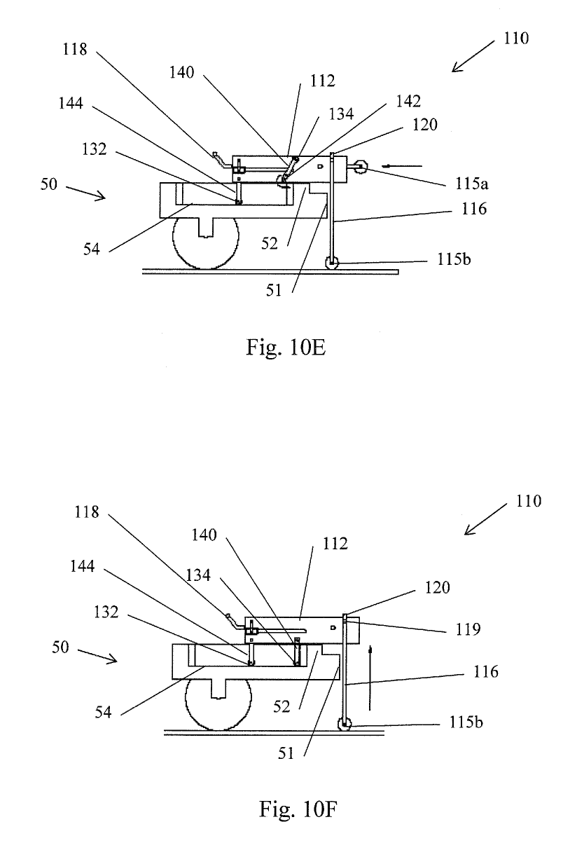

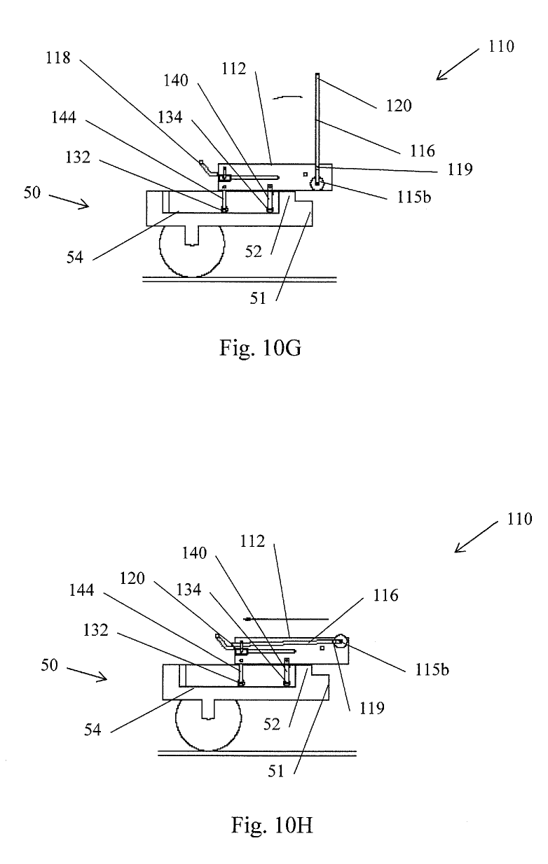

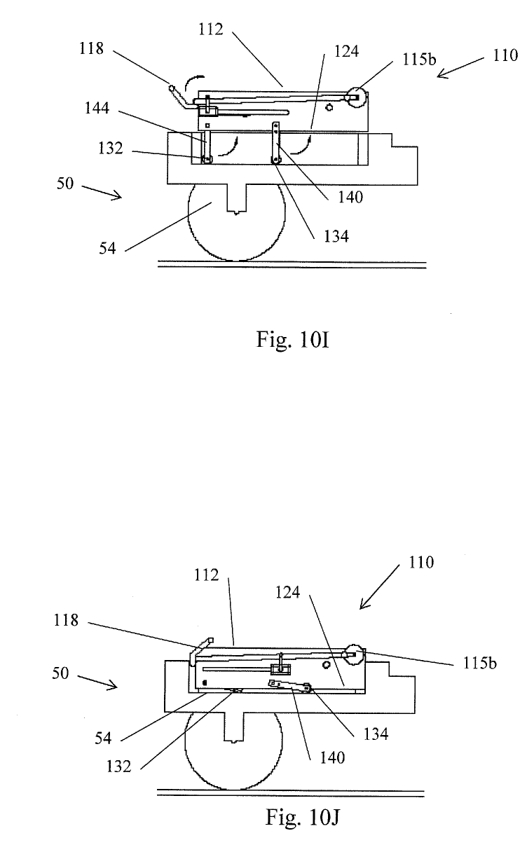

In other embodiments of the present invention, the support legs are deployed by a mechanism that is independent of the retraction of the cart legs. FIG. 9 schematically illustrates a vehicle loadable cart with slanted front legs and separate handles for deploying support legs, in accordance with some embodiments of the present invention. Chassis 112 of cart 110 rests on front cart legs 114 and rear cart legs 116. The bottom ends of front cart legs 114 are provided with front wheels 115a, and rear cart legs 116 are provided with rear wheels 1 15b. Handle 118 is connected to front cart legs 114, and handle 120 is connected to rear cart legs 116. Chassis 112 includes chassis bottom 124 and side walls 112. Front cart legs 114 are slanted so as to extend downward and forward from the rear portion of cart 110. The slant of front cart legs 114 may enable the rear bumper of a vehicle to fit within the space between front cart legs 114 and chassis bottom 124. This enables the front end of chassis 112 to extend over the top of the rear wall of the trunk of a vehicle (as shown in FIG. 10A). Each of side walls 122 is double, consisting of two parallel wall panels 123. Various components of leg deploying and retracting mechanisms are mounted in the space between wall panels 123. Handle 136 slides along slot 126, and is used to extend casters 132 at the ends of front support legs of an auxiliary wheel assembly (see 144 in FIG. 10B). Handle 138 slides along slot 128. When handle 138 is pushed toward the front end of cart 110, handle 138 slides along slot 128. Handle 138 pushes on arm 139, causing rear support leg 140 of an auxiliary wheel assembly to rotate downward around axis 142.

A procedure for loading cart 110 into the trunk of a vehicle is illustrated in FIG. 10A-FIG. 10J. FIG. 10A is a schematic side view of the cart shown in FIG. 9 when in position to be loaded into the trunk of a vehicle. The front end of cart 110 is brought up to above rear trunk wall 52 of trunk 50 of a vehicle. The front end of chassis 112 extends over rear trunk wall 52, and front cart legs 114 abut rear bumper 51 of the vehicle. In order to deploy the front support legs, handle 136 is slid toward the front of chassis 112 along slot 126. Sliding handle 136 forward causes front support legs 144 to rotate forward and downward about axis 146. Front support legs 144 are thus deployed, extending downward with casters 132 resting on trunk floor 54. FIG. 10B schematically illustrates the cart shown in FIG. 10A with front support legs deployed. The front end of chassis 112 is supported by front support legs 144. At this point, front cart legs 114 may be retracted. Handle 118 is pulled diagonally upward and toward the rear of cart 110, causing front cart legs 114 to extend above and rearward of axis 117. FIG. 10C schematically illustrates the cart shown in FIG. 10B with front legs retracted. Handle 118 is now rotated about axis 117 toward the front of cart 110 until front cart legs 114 are folded horizontally within the space between wall panels 123 (shown in FIG. 9). FIG. 10D schematically illustrates the cart shown in FIG. 10C with horizontally folded retracted front legs.

Chassis 112 is now supported by front support legs 144 and rear cart legs 116. Chassis 112 may be pushed forward on front casters 132 and rear wheels 115b, further into trunk 50. When rear cart legs 116 abut rear bumper 51, the rear support legs may be deployed. FIG. 10E schematically illustrates deploying the rear support legs of the cart shown in FIG. 8D. Handle 138 (shown in FIG. 9) is slid forward, causing rear support legs 140 to rotate forward and downward about axis 142. FIG. 10F schematically illustrates the cart shown in FIG. 10E with all support legs deployed. Chassis 112 is supported by front support legs 144 and rear support legs 140. At this point, rear cart legs 116 may be retracted. Handle 120 is pulled vertically upward, causing front cart legs 116 to extend vertically above axis 119. FIG. 10G schematically illustrates the cart shown in FIG. 10F with rear legs retracted. Handle 120 is now rotated about axis 119 toward the front of cart 110 until front cart legs 116 are folded horizontally along the outside of side walls 122 (shown in FIG. 9). FIG. 10H schematically illustrates the cart shown in FIG. 10G with horizontally folded retracted rear legs.

Chassis 112 may now be pushed forward into trunk 50 on front casters 132 and rear casters 134 until chassis 112 is entirely inside trunk 50. In order improve the stability of chassis 112 when the vehicle is in motion, the support legs are retracted. FIG. 10I schematically illustrates retracting the support legs of the cart shown in FIG. 10H. In order to retract front support legs 144 and rear support legs 140, handles 136 and 138 are slid back toward the rear end of chassis 112. Sliding handles 136 and 138 toward the rear end of chassis 112, causes front support legs 144 and rear support legs 140 to rotate upward and toward the rear of chassis 112 (counterclockwise in FIG. 10H). As front support legs 144 and rear support legs 140 rotate, chassis 112 descends. Chassis 112 descends until front support legs 144 and rear support legs 140 rotate are fully retracted. Handle 118 may also be folded upward and rearward over chassis 112, reducing the amount of space occupied by collapsed cart 110. FIG. 10J schematically illustrates the cart shown in FIG. 10I with support legs retracted. At this point, chassis bottom 124 of chassis 112 is resting stably on trunk floor 54. The cover of trunk 50 may now be closed.

It will be clear to a person skilled in the art, that many variations of the embodiments described are possible. In particular, elements of the various embodiments may be combined. For example, a mechanism that was described in connection with one embodiment may be employed to deploy the front support legs, while a mechanism that was described in connection with a different embodiment may be employed to deploy the rear support legs. Such combinations of elements of various embodiments shall be considered as falling within the scope of the present invention.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A vehicle loadable cart for loading into a trunk of a vehicle having a floor and a rear wall which is higher than the floor, the cart comprising:
a chassis;
a retractable main wheel assembly for supporting the chassis when transported over a ground surface;
at least one auxiliary wheel assembly with a deployment mechanism that is adapted to shift the auxiliary wheel assembly between a retracted state in which the auxiliary wheel assembly is raised so as to allow the chassis to pass in a substantially horizontal position over the rear wall of the trunk, and a deployed state in which said at least one auxiliary wheel assembly extends downward so as to support the chassis above the trunk floor at an elevation equal to or higher than the rear wall of the trunk, allowing wheeling the cart further into the trunk,
whereby when the cart is inside the trunk said at least one auxiliary wheel assembly may be retracted to lower the chassis onto the floor of the trunk.

2. The cart of claim 1, wherein said at least one auxiliary wheel assembly comprises a front auxiliary wheel assembly for supporting a front portion of the chassis above the trunk floor.

3. The cart of claim 1, wherein the retractable main wheel assembly and said at least one auxiliary wheel assembly cooperate.

4. The cart of claim 1, wherein said at least one auxiliary wheel assembly comprises a front auxiliary wheel assembly and a rear auxiliary wheel assembly.

5. The cart of claim 1, wherein the retractable main wheel assembly includes front legs and rear legs.

6. The cart of claim 1, wherein the deployment mechanism is manually operable.

7. The cart of claim 6, wherein the deployment mechanism is manually operable by a lever.

8. The cart of claim 1, wherein the deployment mechanism includes a stored-energy element for assisting in the deployment of said at least one auxiliary wheel assembly.

9. The cart of claim 8, wherein the stored-energy element comprises a spring.

10. The cart of claim 1, wherein said at least one auxiliary wheel assembly is adjustable so as to adjust the elevation.

11. The cart of claim 1, wherein the retractable main wheel assembly is adjustable so as to adjust the height of the chassis above the ground surface.

12. The cart of claim 1, wherein the deployment mechanism is automatic.

13. The cart of claim 1, wherein the deployment mechanism comprises a motor.
